(19) United States
(12) Patent Application Publication
(10) Pub. No.: US 2009/0016359 A1
(43) Pub. Date: Jan. 15, 2009

(54) SYSTEM AND METHOD FOR PROCESSING HIGH DEFINITION VIDEO DATA TO BE TRANSMITTED OVER A WIRELESS MEDIUM

(75) Inventors: Huaning Niu, Sunnyvale, CA (US); Pengfei Xia, Mountain View, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon (KR)

(21) Appl. No.: 11/776,506

(22) Filed: Jul. 11, 2007

(51) Int. Cl. H04L 12/56

(52) U.S. Cl. 370/395.64

(57) ABSTRACT

A system and method for processing high definition video data to be transmitted over a wireless medium is disclosed. In one embodiment, the system includes i) at least one convolutional encoder configured to input a plurality of video data streams and output a plurality of encoded data streams, each of the plurality of encoded data streams comprises a plurality of data bits, ii) at least one multiplexer configured to multiplex the plurality of encoded data streams into a multiplexed data stream based on a multiplexing order, wherein the multiplexing order represents the number of data bits multiplexed together at one time and iii) a quadrature amplitude modulation (QAM) mapper configured to perform QAM mapping for the multiplexed data stream. At least one embodiment provides a simple, yet effective, solution using an s-group multiplexing instead of bit-by-bit multiplexing.

### RELATED APPLICATIONS

This application relates to U.S. patent application Ser. No. 11/724,760 filed on Mar. 15, 2007, which is incorporated by reference.

### BACKGROUND OF THE INVENTION

1. Field of the Invention

The present invention relates to wireless transmission of video information, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require about 1 Gbps (bits per second) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices, which do not have the bandwidth to carry the uncompressed HD signals, are connected to the network.

### SUMMARY OF CERTAIN INVENTIVE ASPECTS

One aspect of the invention provides a system for processing high definition video data to be transmitted over a wireless medium, the system comprising: i) at least one convolutional encoder configured to input a plurality of video data streams and output a plurality of encoded data streams, each of the plurality of encoded data streams comprises a plurality of data bits, ii) at least one multiplexer configured to multiplex the plurality of encoded data streams into a multiplexed data stream based on a multiplexing order, wherein the multiplexing order represents the number of data bits multiplexed together at one time and iii) a quadrature amplitude modulation (QAM) mapper configured to perform QAM mapping for the multiplexed data stream.

Another aspect of the invention provides a method of processing uncompressed high definition video data to be transmitted over a wireless medium, the method comprising: i) convolutional encoding a plurality of video data streams in parallel into a plurality of encoded data streams, each of the plurality of encoded data streams comprises a plurality of data bits, ii) determining a multiplexing order based on at least one quadrature amplitude modulation (QAM) symbol, iii) multiplexing the plurality of encoded data streams into a multiplexed data stream based on the multiplexing order, wherein the multiplexing order represents the number of data bits multiplexed together at one time and iv) performing QAM mapping for the multiplexed data stream.

Another aspect of the invention provides one or more processor-readable storage devices having processor-readable code embodied on the processor-readable storage devices, the processor-readable code for programming one or more processors to perform a method of processing high definition video data to be transmitted over a wireless medium, the method comprising: i) convolutional encoding a plurality of video data streams in parallel into a plurality of encoded data streams, each of the plurality of encoded data streams comprises a plurality of data bits, ii) determining a multiplexing order based on at least one quadrature amplitude modulation (QAM) symbol, iii) multiplexing the plurality of encoded data streams into a multiplexed data stream based on the multiplexing order, wherein the multiplexing order represents the number of data bits multiplexed together at one time and iv) performing QAM mapping for the multiplexed data stream.

Still another aspect of the invention provides a system for processing uncompressed high definition video data to be transmitted over a wireless medium, the system comprising: i) means for convolutional encoding a plurality of video data streams in parallel into a plurality of encoded data streams, each of the plurality of encoded data streams comprises a plurality of data bits, ii) means for determining a multiplexing order based on at least one quadrature amplitude modulation (QAM) symbol, iii) means for multiplexing the plurality of encoded data streams into a multiplexed data stream based on the multiplexing order, wherein the multiplexing order represents the number of data bits multiplexed together at one time and iv) means for performing QAM mapping for the multiplexed data stream.

Yet another aspect of the invention provides a system for processing high definition video data to be transmitted over a wireless medium, the system comprising: i) an outer encoder configured to outer encode a plurality of received video data streams into a first plurality of encoded data streams, ii) an outer interleaver configured to outer interleave the first plurality of encoded data streams into a plurality of outer interleaved data streams, iii) an inner encoder configured to inner encode the outer interleaved data streams to a second plurality of encoded data streams, each of the second encoded data streams comprises a plurality of data bits, iv) a multiplexer configured to 1) determine a multiplexing order based on at least one quadrature amplitude modulation (QAM) symbol and 2) multiplex the plurality of second encoded data streams into a multiplexed data stream based on the multiplexing order, wherein the multiplexing order represents the number of data bits multiplexed together at one time and v) a QAM mapper configured to perform QAM mapping for the multiplexed data stream.

Yet another aspect of the invention provides a system for processing high definition video data to be transmitted over a wireless medium, the system comprising: i) at least one convolutional encoder configured to input a plurality of video data streams and output a plurality of encoded data streams, each of the plurality of encoded data streams comprises a plurality of data bits, ii) at least one multiplexer configured to multiplex the plurality of encoded data streams into a multiplexed data stream, wherein the at least one multiplexer is further configured to multiplex a plurality of data bits of each encoded data stream together at one time and iii) a quadrature amplitude modulation (QAM) mapper configured to perform QAM mapping for the multiplexed data stream.

### BRIEF DESCRIPTION OF THE DRAWINGS

FIG. 1 is a functional block diagram of a wireless network that implements uncompressed HD video transmission between wireless devices according to one embodiment.

FIG. 2 is a functional block diagram of an example communication system for transmission of uncompressed HD video over a wireless medium, according to one embodiment.

FIG. 3 illustrates a conceptual diagram showing 16 QAM constellation according to a typical HD video data transmitter for a wireless video area network (WVAN).

FIG. 4 illustrates a conceptual diagram showing four bits decision region used for calculating the soft decision metrics for soft Viterbi decoding.

FIG. 5 illustrates an input bit pattern of 16 QAM constellation with bit-by-bit multiplexing according to a typical HD video data transmitter for a WVAN.

FIG. 6 illustrates an exemplary HD video data transmitter system according to one embodiment of the invention.

FIG. 7 illustrates an input bit pattern of 16 QAM constellation with s-group multiplexing according to one embodiment of the invention.

FIG. 8 is a graph showing performance comparison in simulation setting 1 according to one embodiment of the invention.

FIG. 9 is a graph showing performance comparison in simulation setting 2 according to another embodiment of the invention.

FIG. 10 is a flowchart for a transmitting procedure including an s-group multiplexing method according to one embodiment of the invention.

### DETAILED DESCRIPTION OF CERTAIN INVENTIVE EMBODIMENTS

Certain embodiments provide a method and system for transmission of uncompressed HD video information from a sender to a receiver over wireless channels.

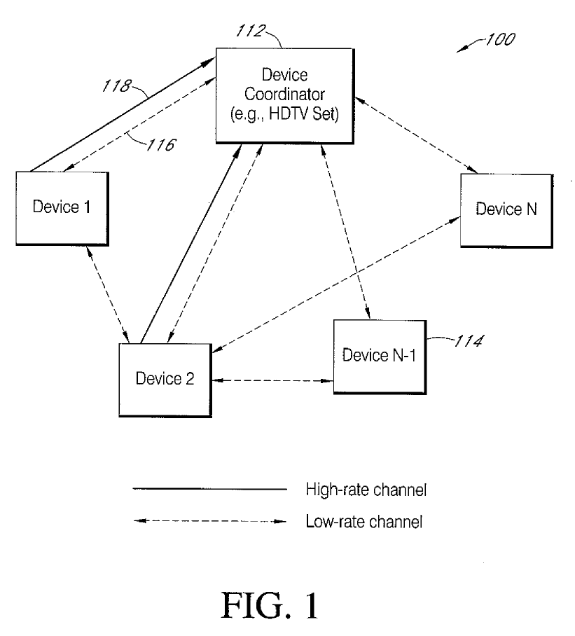

Example implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1, Device 2, . . . , Device N). The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114.

Each station 114 uses the low-rate channel 116 for communications with other stations 114. The high-rate channel 118 supports single direction unicast transmission over directional beams established by beamforming, with e.g., multi-GB/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a sender of the video information (hereinafter “sender 114”). For example, the receiver 112 can be a sink of video and/or audio data implemented, such as, in an HDTV set in a home wireless network environment which is a type of WLAN. In another embodiment, the receiver 112 may be a projector. The sender 114 can be a source of uncompressed video or audio. Examples of the sender 114 include a set-top box, a DVD player or recorder, digital camera, camcorder, other computing device (e.g., laptop, desktop, PDA, etc.) and so forth.

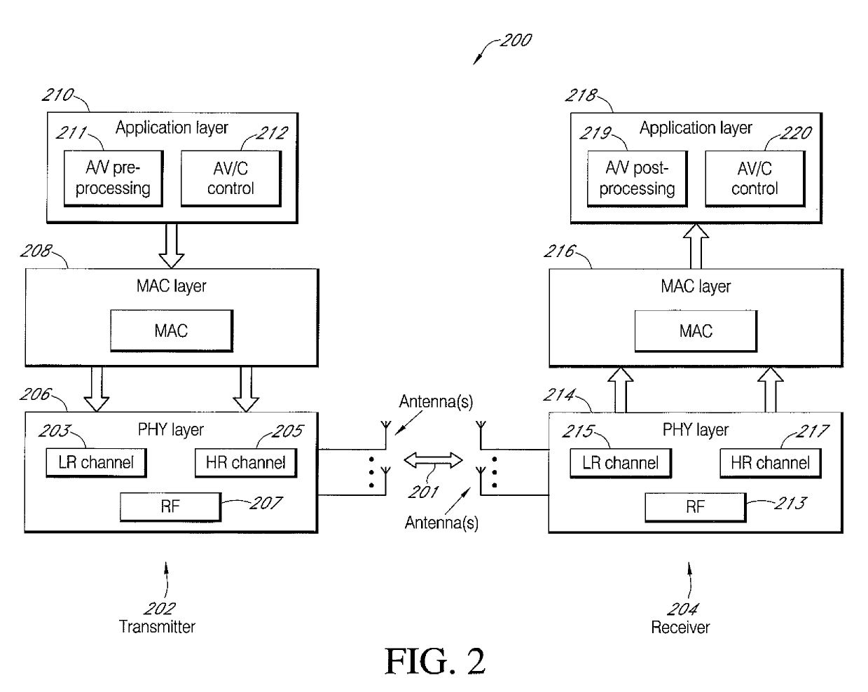

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216 process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

In a typical HD video data transmitter for a wireless video area network (WVAN), a bit-by-bit multiplexing is often used. However, the key problem with a bit-by-bit multiplexing is that, when quadrature amplitude modulation (QAM) order is a factor of the number of convolutional (or inner) encoders, the encoded bits from different convolutional encoders receive different degrees of error protection. This will cause long runs of weakly protected bits at the input of certain Viterbi decoders, therefore degrade the overall system performance. For example, when using eight convolutional encoders together with, for example, 16QAM modulation (modulation order S=4), which satisfies the integer-multiple relationship, the overall bit error ratio (BER) performance will degrade.

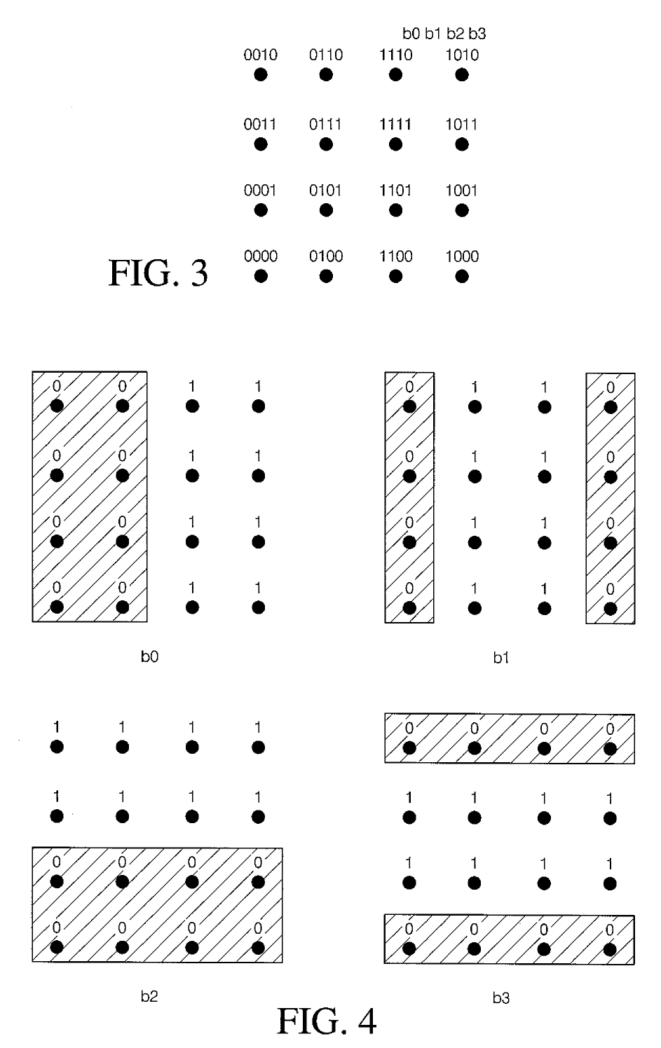

A puncture-cycle based multiplexer design is proposed in U.S. patent application Ser. No. 11/724,760 filed on Mar. 15, 2007 entitled “System and method for digital communication having puncture cycle based multiplexing scheme with unequal error protection (UEP),” which is incorporated by reference. However, with respect to equal error protection (EEP), the multiplexer of the above application simplifies to a simple bit-by-bit multiplexer. The problem of bit-by-bit multiplexing when QAM modulation order (S) is a factor of the number of convolutional encoders (or inner encoders; hereinafter frequently used as “convolutional encoders” for convenience) will be further described with respect to FIGS. 3-5. QAM modulation order S is defined as the number of bits per QAM symbol. For example, S=1 for binary phase shift keying (BPSK) constellation, S=2 for quadrature phase shift keying (QPSK) constellation, S=4 for 16 QAM constellation and S=6 for 64 QAM constellation. The bit-by-bit multiplexer generally provides the greatest protection or flexibility when the number of convolutional encoders is not an integer multiple of S, e.g., when five convolutional encoders are used in the I-branch with 16 QAM modulation. However, as briefly discussed above, if the number of convolutional encoders is an integer multiple of S, the bit-by-bit multiplexer will suffer from the “QAM-order” problem, i.e., long runs of weakly protected bits being observed at the input of a certain Viterbi decoder.

To better illustrate the “QAM-order” problem, the four bit (b0-b3) decision regions for 16 QAM are shown in FIG. 3 and the gray labeling pattern thereof is shown in FIG. 4. Referring to FIG. 4, bits b0 and b2 have only one closest neighbor (one set of unshaded 1111 bits next to the two sets of shaded 1111 bits), while bits b1 and b3 have two closest neighbors (two sets of unshaded 1111 bits bordering one set of shaded 1111 bits on each side). As is generally known, the bits having less “closest neighbor(s)” are better (error) protected than the bits having more “closest neighbor(s).” Therefore, bits b0 and b2 are generally better protected than bits b1 and b3. Similar observation can be made for gray labeled 64 QAM modulation, where per QAM symbol, two bits are strongly protected, two bits are weakly protected, and the degree of protection for the remaining two bits stays in the middle.

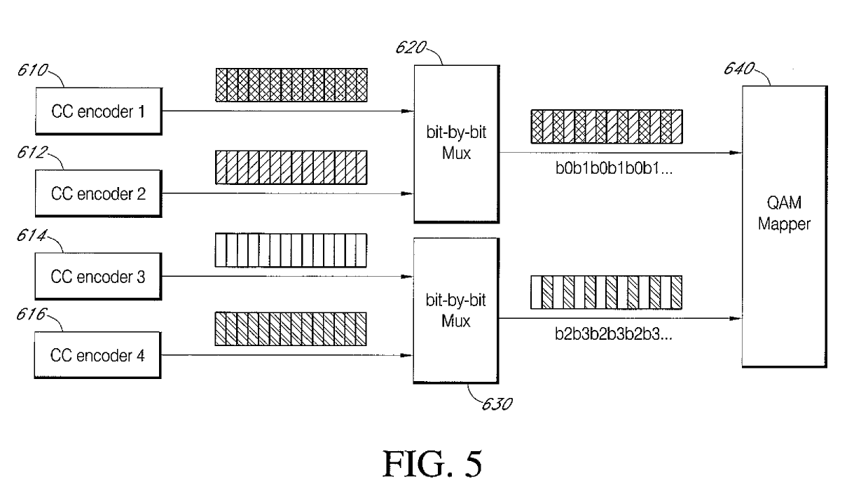

Take four convolutional encoders with 16 QAM mapping, for example, as shown in FIG. 5. When bit-by-bit multiplexing is used, the coded bits from the output of a first encoder 610 are mapped into bit b0 in the QAM constellation. Similarly, the coded bits from the output of a second encoder 612 are mapped into bit b1 in the QAM constellation. A bit-by-bit multiplexer 620 performs bit-by-bit multiplexing with respect to the received bits b0 and b1. Thereafter, the series of bits (b0b1b0b1b0b1 . . . ) are provided to the I (or Q) branch of a QAM mapper 640 for QAM mapping.

Furthermore, the outputs of third and fourth encoders 614 and 616 are mapped to b2 and b3, respectively. A bit-by-bit multiplexer 630 performs bit-by-bit multiplexing with respect to the received bits b2 and b3. Thereafter, the series of bits (b2b3b2b3b2b3 . . . ) are provided to the Q (or I) branch of the QAM mapper 640 for QAM mapping.

As discussed with respect to FIGS. 3 and 4, since bits b1 and b3 are weakly protected in the 16QAM constellation, the second and the forth encoders 612 and 616 will experience inferior performance compared to the first and third encoders 610 and 614. As a result, the RS code error correction capability is dominated by those encoders 612 and 616 having poor performance, and the overall system BER performance degrades.

One embodiment of the invention provides a simple, yet effective, solution using an s-group multiplexing instead of bit-by-bit multiplexing, wherein s=max (S/2, 1), where S is QAM modulation order. Another embodiment of the invention provides an improved EEP design by using a group multiplexing.

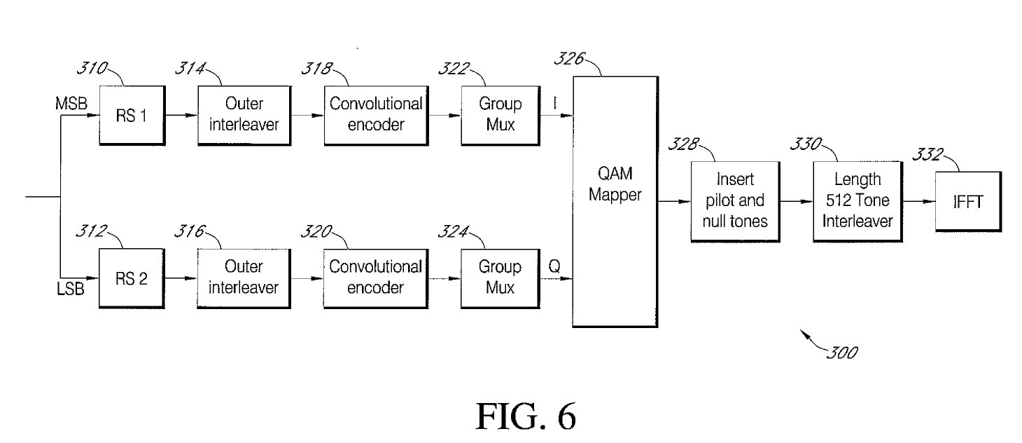

FIG. 6 illustrates an exemplary HD video data transmitter system 300 for a WVAN according to one embodiment of the invention. The system 300 may include Reed Solomon (RS) encoders 310 and 312, outer interleavers 314 and 316, convolutional encoders 318 and 320, group multiplexers 322 and 324, a QAM mapper 326, a pilot and null tone inserting unit 328, an interleaver 330 and an inverse Fourier Fast Transform (IFFT) unit 332. In one embodiment, all of the elements of the FIG. 3 system 300 belong to the PHY layer 206 (see FIG. 2).

In one embodiment, instead of using the RS encoders 310 and 312, other outer encoders such as a BCH (Bose, Ray-Chaudhuri, Hocquenghem) encoder can be also used. In one embodiment, instead of using the convolutional encoders 318 and 320, other inner encoders such as a linear block encoder can be also used. In one embodiment, each of the convolutional encoders 318 and 320 may include a plurality of parallel convolutional encoders which encode a plurality of incoming data bits, respectively. In this embodiment, the system 300 may further include at least one parser (not shown), between each of the outer interleavers 314, 316 and each of the convolutional encoders 318 and 320, which parses the outer interleaved data bits to the corresponding convolutional encoders 318 and 320.

In another embodiment, it is also possible to have a single RS (or outer) encoder, a single outer interleaver and a single group multiplexer instead of using a pair of those elements 310-324 as shown in FIG. 3. In another embodiment, it is also possible to have more than two of the RS encoders, outer interleavers, convolutional encoders and group multiplexers.

In one embodiment, the elements 310, 314, 318 and 322 are used to process most significant bits (MSBs) and the elements 312, 316, 320 and 324 are used to process least significant bits (LSBs). In one embodiment, the MSBs are mapped into I-branch of the QAM constellation and the LSBs are mapped into Q-branch of the QAM constellation.

In one embodiment, MSBs and LSBs are equally protected (EEP) with respect to error codings. In one embodiment, all of the elements of the FIG. 3 system 300 can be embodied by either software or hardware or a combination.

The RS encoders 310, 312 and outer interleavers 314, 316 perform RS encoding and outer interleaving with respect to incoming bit streams (MSBs and LSBs, respectively). In one embodiment, each of the outer interleavers 312, 332 is a block interleaver or a convolutional interleaver. In another embodiment, other forms of interleavers are also possible.

In one embodiment, the number of convolutional (or inner) encoders for MSB data may be the same (e.g., 4 and 4) as that of inner encoders for LSB data. In another embodiment, the number of convolutional (or inner) encoders for MSB data may be different (e.g., 6 and 2) from that of inner encoders for LSB data.

In one embodiment, the convolutional encoders 318 and 320 are configured to provide equal error protection (EEP) for all incoming data bits. A description regarding the operation of convolutional encoders in HD video data processing for a WVAN is explained in U.S. patent application Ser. No. 11/724,758 filed on Mar. 15, 2007 entitled “System and method for digital communication using multiple parallel encoders,” which is incorporated by reference.

In one embodiment, the RS encoders 310, 312, outer interleavers 314, 316 and the encoders 318 and 320 together perform the forward error correction (FEC) described with respect to FIG. 2.

The group multiplexers 322, 324 (will be described in greater detail later) combine the bit streams of the encoders 318 and 320, respectively, and provide the multiplexed data to the QAM mapper 326. In one embodiment, the output of the multiplexer 322 is provided to the I (or Q) branch of the QAM mapper 326 and the output of the multiplexer 324 is provided to the Q (or I) branch of the mapper 326. The QAM mapper 326 performs QAM mapping for the received multiplexed data.

The pilot and null tone inserting unit 328 inserts pilot and null tones into the QAM mapped data. The interleaver 330 performs length 512 tone interleaving on the output of the element 328. It is appreciated that the numbers of pilot and null tones in the unit 328 and the number of tones in the interleaver 330 may vary according to embodiments. The IFFT unit 332 performs inverse Fourier Fast Transform (IFFT) processing on the output of the interleaver 330. After the interleaving, beamforming may be performed before transmitting the data packet to a HD video data receiver for a WVAN over the wireless channel 201 (see FIG. 2). In one embodiment, the HD video data receiver may include a single convolutional decoder or a plurality of convolutional decoders corresponding to the convolutional encoder(s) of the transmitter system 300.

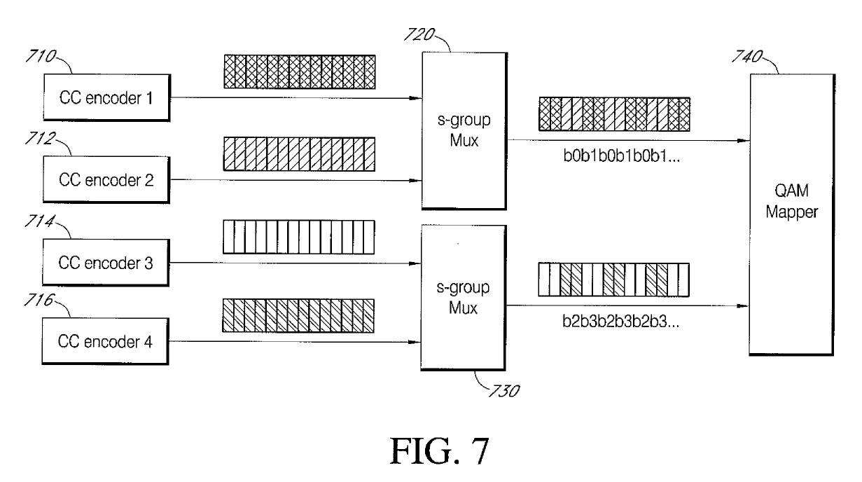

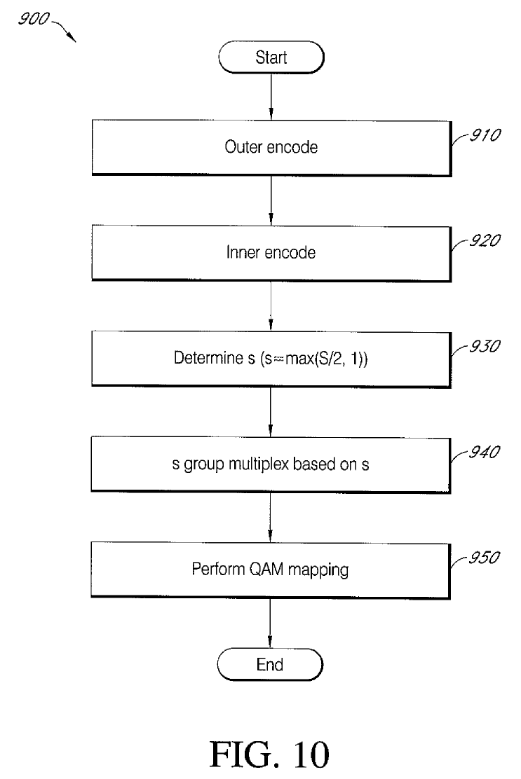

Hereinafter, referring to FIGS. 6, 7 and 10, the operation of the system 300 will be described. FIG. 7 illustrates an input bit pattern of 16 QAM constellation with s-group multiplexing according to one embodiment of the invention. FIG. 10 is a flowchart for a transmitting procedure 900 including a s-group multiplexing method according to one embodiment of the invention.

In one embodiment, the transmitting procedure 900 is implemented in a conventional programming language, such as C or C++ or another suitable programming language. In one embodiment of the invention, the program is stored on a computer accessible storage medium at a HD video data transmitter for a WVAN, for example, a device coordinator 112 or devices (1-N) 114 as shown in FIG. 1. In another embodiment, the program can be stored in other system locations so long as it can perform the transmitting procedure 900 according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

In another embodiment, at least one of the device coordinator 112 and devices (1-N) 114 comprises a processor (not shown) configured to or programmed to perform the transmitting procedure 900. The program may be stored in the processor or a memory of the coordinator 112 and/or the devices (1-N) 114. In various embodiments, the processor may have a configuration based on Intel Corporation's family of microprocessors, such as the Pentium family and Microsoft Corporation's Windows operating systems such as Windows 95, Windows 98, Windows 2000 or Windows NT. In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9x/ME/XP, Macintosh OS, OS/2 and the like. In another embodiment, the transmitting procedure 900 can be implemented with an embedded software. Depending on the embodiments, additional states may be added, others removed, or the order of the states changes in FIG. 10. In FIG. 10, certain states (e.g., functions associated with the elements 314, 316 and 328-332 in FIG. 6) are omitted.

In state 910, outer encoding for incoming data bits is performed in the RS encoders 310 and 312 (or other outer encoder). In state 920, inner encoding for outer interleaved data bits is performed in the convolutional encoders 310 and 312 (or other inner encoder). Each of the group multiplexers 322 and 324 (FIG. 6) determines s (s=max (S/2, 1); hereinafter s will be referred to “multiplexing order” for convenience) (930). In one embodiment, s=1 for BPSK and QPSK modulations, s=2 for 16 QAM modulation (S=4) and s=3 for 64 QAM modulation (S=6). The multiplexing order s represents the number of bits multiplexed together at each time.

Each of the group multiplexers 322 and 324 performs s-group multiplexing for the incoming data bits based on the determined multiplexing order s (940). For example, if s=1 (e.g., for BPSK and QPSK), each multiplexer 322, 324 multiplexes one bit at each time. If s=2 (e.g., for 16 QAM), each multiplexer 322, 324 multiplexes a group of two bits together at each time. If s=3 (e.g., for 64 QAM), each multiplexer 322, 324 multiplexes a group of three bits together at each time.

Referring to FIG. 7, the operation of multiplexers 720 and 730 (s=2) will be described in greater detail. In this embodiment, two bits are multiplexed together at each time. The output of a first encoder 710 is mapped onto b0b1 of the first QAM symbol. The output of a second encoder 712 is mapped to b0b1 of the second QAM symbol. Similarly, the output of a third encoder 714 is mapped onto b2b3 of the first QAM symbol and the output of a fourth encoder 716 is mapped onto b2b3 of the second QAM symbol. In this way, each convolutional encoder provides a mix of strongly protected bits (b0 and b2) and weakly protected bits (b1 and b3). That is, the strongly (b0) and weakly (b1) protected bits alternate in the bit stream as seen from “b0b1b0b1 . . . ” in FIG. 7. Furthermore, the strongly (b2) and weakly (b3) protected bits alternate in the bit stream as seen from “b2b3b2b3 . . . ” in FIG. 7. This can avoid the QAM-order problem because long runs of weakly protected bits are not observed at the input of a certain Viterbi decoder. It is appreciated that the FIG. 7 example is merely corresponding to the bit labeling pattern shown in FIG. 4. In another embodiment, a similar s-group multiplexer can be used for other Gray labeled QAM symbols as well.

Similarly, if s=3 (e.g., for 64 QAM), each multiplexer 322, 324 (FIG. 6) multiplexes a group of three bits together at each time. In this embodiment, the three bits include 1) a first one of the three data bits which is strongly protected, 2) a second one of the three data bits which is weakly protected, and 3) the remaining data bit which stays in the middle (i.e., neither strongly nor weakly protected). In this embodiment, each convolutional encoder provides a mix of a strongly protected bit, a weakly protected bit and the data bit staying in the middle, which can avoid the QAM-order problem. In another embodiment, a plurality of data bits are multiplexed together at each time. In this embodiment, at least one data bit may be more strongly error protected with respect to the other data bits by convolutional encoders and at least one data bit may be more weakly error protected with respect to the other data bits by convolutional encoders. Furthermore, at least one data bit stays in the middle between the strongly and weakly error protected bits in terms of the degree of error protection. However, since data bits having different degrees of error protection are mixed, overall each of the plurality of parallel convolutional encoders is configured to provide equal error protection for incoming data bits with respect to the remaining convolutional encoders.

Referring to FIG. 7, four convolutional (or inner) encoders 710-716 for 116QAM constellation are shown. However, it is appreciated that other combinations with respect to the number of the inner encoders (e.g., 2, 6 or 8) and the type of QAM constellation (e.g., 64 or 128 QAM) are also possible. The QAM mapper 740 performs QAM mapping for the s-group multiplexed data bits (950).

### EXAMPLE 1

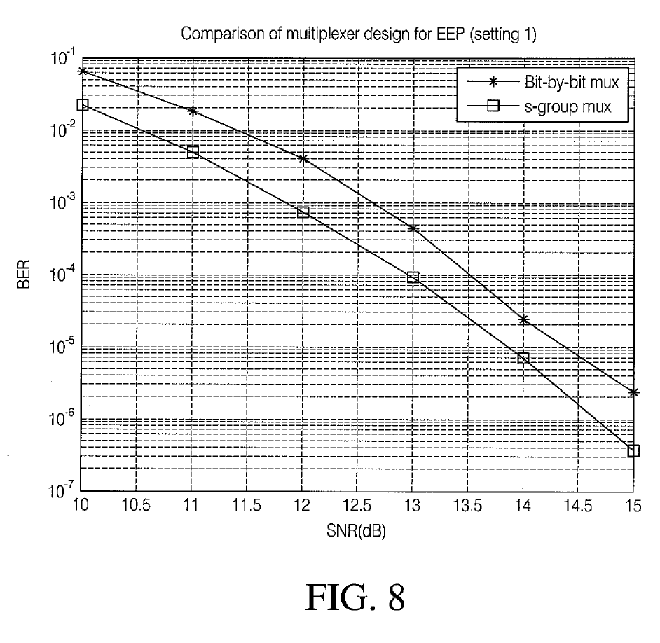

The performance improvement using the s-group multiplexer is simulated and compared to the bit-by-bit multiplexer in two different settings. In the first setting as illustrated in FIG. 8, it is simulated using the following parameters and the simulation performance. However, it is appreciated that the following numerical values are merely examples and many other combinations of numbers are also possible.
RS code (224,220),
Depth-3 outer-leaver with byte wise parsing to parallel convolutional encoders,
8 convolutional encoders,
Gray label 16 QAM constellation,
Post-beamforming fading channel, and
Size 512 channel interleaver (after inserting pilot and null tones)

Specifically, the curve with star presents the simulation result with bit-by-bit multiplexing, while the curve with square is the simulation results with s-group multiplexing (s=2 in this particular example). It can be seen from FIG. 8 that better performance is achieved by using the s-group multiplexing without adding any additional complexity.

### EXAMPLE 2

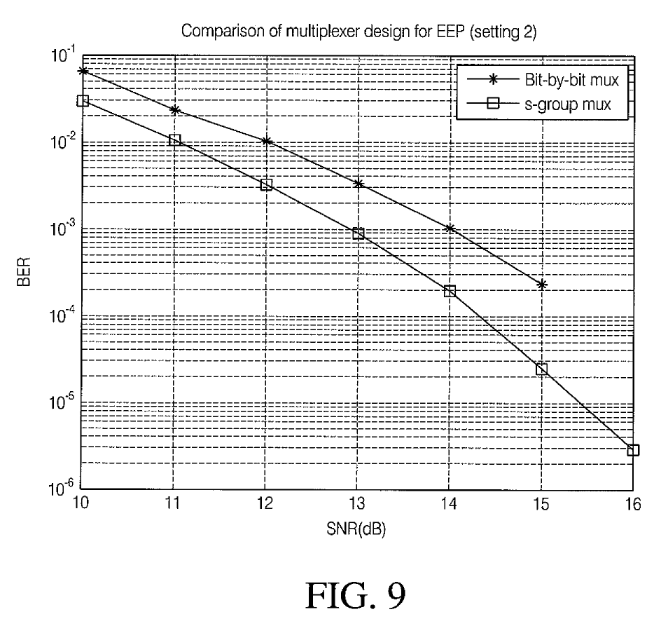

In the second setting as illustrated in FIG. 9, it is simulated using the following parameters with the simulation results. Again, it is appreciated that the following numerical values are merely examples and many other combinations of numbers are also possible.
RS code (224,220),
Depth-4 outer-leaver with 4-byte wise parsing to parallel convolutional encoders,
8 convolutional encoders,
Gray label 16QAM constellation,
Post-beamforming fading channel and
Size 336 channel interleaver (before inserting pilot and null tones)

In particular, the curve with star presents the simulation results with bit-by-bit multiplexing, while the curve with square illustrate the simulation results with s-group multiplexing (s=2 in this particular example). It can be seen from FIG. 9 that better performance is also achieved by using the s-group multiplexing without adding any additional complexity.

According to at least one embodiment, using the s-group multiplexer where s=max (S/2, 1), with S being QAM modulation order, significant performance improvement can be achieved in HD video systems for a WVAN with multiple parallel convolutional encoders. One embodiment of the invention provides an improved performance for EEP regardless of the number of encoders.

While the above description has pointed out novel features of the invention as applied to various embodiments, the skilled person will understand that various omissions, substitutions, and changes in the form and details of the device or process illustrated may be made without departing from the scope of the invention. For example, although embodiments of the invention have been described with reference to uncompressed video data, those embodiments can be applied to compressed video data as well.

Therefore, the scope of the invention is defined by the appended claims rather than by the foregoing description. All variations coming within the meaning and range of equivalency of the claims are embraced within their scope.

What is claimed is:

1. A system for processing high definition video data to be transmitted over a wireless medium, the system comprising:
at least one convolutional encoder configured to input a plurality of video data streams and output a plurality of encoded data streams, each of the plurality of encoded data streams comprises a plurality of data bits;
at least one multiplexer configured to multiplex the plurality of encoded data streams into a multiplexed data stream based on a multiplexing order, wherein the multiplexing order represents the number of data bits multiplexed together at one time; and
a quadrature amplitude modulation (QAM) mapper configured to perform QAM mapping for the multiplexed data stream.

2. The system of claim 1, wherein the at least one convolutional encoder comprises a plurality of parallel convolutional encoders configured to input the plurality of video data streams and output the plurality of encoded data streams to the at least one multiplexer, respectively.

3. The system of claim 2, wherein the multiplexing order (s) is defined as s=max (S/2, 1), and wherein S is a QAM modulation order.

4. The system of claim 3, wherein the QAM modulation order (S) is 1 for binary phase shift keying (BPSK) constellation and 2 for quadrature phase shift keying (QPSK) constellation, wherein each of the at least one multiplexer is further configured to multiplex one bit at each time.

5. The system of claim 3, wherein the QAM modulation order (S) is 4 for 16 QAM, wherein each of the at least one multiplexer is further configured to multiplex two data bits together at each time.

6. The system of claim 5, wherein one of the two data bits is more strongly error protected with respect to the other data bit by mapping to a Gray labeled QAM constellation.

7. The system of claim 6, wherein each of the plurality of parallel convolutional encoders is configured to provide equal error protection for incoming data bits with respect to the remaining convolutional encoders.

8. The system of claim 3, wherein the QAM modulation order (S) is 6 for 64 QAM, wherein each of the at least one multiplexer is further configured to multiplex three data bits together at each time.

9. The system of claim 8, wherein one of the three data bits is more strongly error protected with respect to the other two data bits by mapping to the most significant bit in the gray labeled 64QAM constellation, wherein one of the three data bits is more weakly error protected with respect to the other two data bits by mapping to the least significant bit in the gray labeled 64QAM constellation, and wherein the remaining data bit stays in the middle between the strongest and weakest protected data bits with respect to error protection.

10. The system of claim 9, each of the plurality of parallel convolutional encoders is configured to provide equal error protection for incoming data bits with respect to the remaining convolutional encoders.

11. The system of claim 2, wherein a portion of the convolutional encoders are configured to encode the most significant bits (MSBs) of a video data stream, and wherein the remaining portion of convolutional encoders are configured to encode the least significant bits (LSBs) of the video data stream.

12. The system of claim 11, wherein the at least one multiplexer comprises a first multiplexer configured to multiplex the MSBs and a second multiplexer configured to multiplex the LSBs.

13. The system of claim 2, further comprising:
at least one Reed Solomon (RS) encoder configured to RS encode an input bit stream into an RS encoded data stream;
at least one outer interleaver configured to outer interleave the RS encoded data stream; and
at least one parser configured to parse the outer interleaved data stream to the plurality of convolutional encoders, respectively.

14. The system of claim 3, wherein the number of the plurality of convolutional encoders is an integer multiple of the QAM modulation order (S).

15. The system of claim 2, further comprising an RF unit configured to transmit the multiplexed data stream to a wireless high definition video receiver which includes a plurality of parallel convolutional decoders corresponding to the plurality of convolutional encoders.

16. The system of claim 15, wherein the receiver is a HDTV set, a projector or a computing device.

17. The system of claim 1, wherein the system is implemented with one of the following: a set-top box, a DVD player or recorder, a digital camera, a camcorder and a computing device.

18. The system of claim 1, wherein the at least one multiplexer is further configured to determine the multiplexing order based on at least one QAM symbol.

19. A method of processing uncompressed high definition video data to be transmitted over a wireless medium, the method comprising:
convolutional encoding a plurality of video data streams in parallel into a plurality of encoded data streams, each of the plurality of encoded data streams comprises a plurality of data bits;
determining a multiplexing order based on at least one quadrature amplitude modulation (QAM) symbol;
multiplexing the plurality of encoded data streams into a multiplexed data stream based on the multiplexing order, wherein the multiplexing order represents the number of data bits multiplexed together at one time; and
performing QAM mapping for the multiplexed data stream.

20. The method of claim 19, wherein the multiplexing order (s) is defined as s=max (S/2, 1), and wherein S is a QAM modulation order.

21. The method of claim 20, wherein the multiplexing comprises multiplexing a plurality of data bits together at each time.

22. The method of claim 21, wherein the convolutional encoding provides different degrees of error protection for each of the plurality of data bits so as to provide equal error protection for all of the plurality of data bits.

23. The method of claim 19, further comprising:
Reed Solomon (RS) encoding an input bit stream into an RS encoded data stream;
outer interleaving the RS encoded data stream; and
parsing the outer interleaved data stream with respect to the plurality of video data streams, wherein the outer interleaved data stream is provided as the plurality of video data streams for the convolutional encoding.

24. The method of claim 19, wherein the video data includes image data and non-image data.

25. One or more processor-readable storage devices having processor-readable code embodied on the processor-readable storage devices, the processor-readable code for programming one or more processors to perform a method of processing high definition video data to be transmitted over a wireless medium, the method comprising:
convolutional encoding a plurality of video data streams in parallel into a plurality of encoded data streams, each of the plurality of encoded data streams comprises a plurality of data bits;
determining a multiplexing order based on at least one quadrature amplitude modulation (QAM) symbol, and
multiplexing the plurality of encoded data streams into a multiplexed data stream based on the multiplexing order, wherein the multiplexing order represents the number of data bits multiplexed together at one time; and
performing QAM mapping for the multiplexed data stream.

26. A system for processing uncompressed high definition video data to be transmitted over a wireless medium, the system comprising:
means for convolutional encoding a plurality of video data streams in parallel into a plurality of encoded data streams, each of the plurality of encoded data streams comprises a plurality of data bits;
means for determining a multiplexing order based on at least one quadrature amplitude modulation (QAM) symbol;
means for multiplexing the plurality of encoded data streams into a multiplexed data stream based on the multiplexing order, wherein the multiplexing order represents the number of data bits multiplexed together at one time; and
means for performing QAM mapping for the multiplexed data stream.

27. A system for processing high definition video data to be transmitted over a wireless medium, the system comprising:
an outer encoder configured to outer encode a plurality of received video data streams into a first plurality of encoded data streams;
an outer interleaver configured to outer interleave the first plurality of encoded data streams into a plurality of outer interleaved data streams;
an inner encoder configured to inner encode the outer interleaved data streams to a second plurality of encoded data streams, each of the second encoded data streams comprises a plurality of data bits;
a multiplexer configured to 1) determine a multiplexing order based on at least one quadrature amplitude modulation (QAM) symbol and 2) multiplex the plurality of second encoded data streams into a multiplexed data stream based on the multiplexing order, wherein the multiplexing order represents the number of data bits multiplexed together at one time; and
a QAM mapper configured to perform QAM mapping for the multiplexed data stream.

28. The system of claim 27, wherein the outer error encoder is a Reed Solomon (RS) encoder or a BCH encoder.

29. The system of claim 27, wherein the inner encoder is a convolutional encoder or a linear block encoder.

30. A system for processing high definition video data to be transmitted over a wireless medium, the system comprising:
at least one convolutional encoder configured to input a plurality of video data streams and output a plurality of encoded data streams, each of the plurality of encoded data streams comprises a plurality of data bits;
at least one multiplexer configured to multiplex the plurality of encoded data streams into a multiplexed data stream, wherein the at least one multiplexer is further configured to multiplex a plurality of data bits of each encoded data stream together at one time; and
a quadrature amplitude modulation (QAM) mapper configured to perform QAM mapping for the multiplexed data stream.
